(19) United States
(12) Patent Application Publication
(10) Pub. No.: US 2015/0375674 A1
(43) Pub. Date: Dec. 31, 2015

(54) ILLUMINATED AUTOMOBILE BADGE

(71) Applicants: Aleksandr Alekseevich ZHAROV, Moscow (RU); Sergei Yurievich IVANOV, Ximki, Moscow region (RU)

(72) Inventors: Aleksandr Alekseevich ZHAROV, Moscow (RU); Sergei Yurievich IVANOV, Ximki, Moscow region (RU)

(21) Appl. No.: 14/767,010

(22) PCT Filed: Jan. 17, 2013
(86) PCT No.: PCT/RU2013/000034

§ 371 Date: Aug. 11, 2015

(30) Foreign Application Priority Data
Aug. 21, 2012 (RU) 2012135766

(51) Int. Cl. B60Q 1/56; B60Q 1/26

(52) U.S. Cl. CPC B60Q 1/56; B60Q 1/2661

(57) ABSTRACT

The invention relates to decorative elements for automobiles. A light source, a translucent element with a first wall and a second wall, and a non-translucent layer or a material for the production thereof are prepared. Using, for example, a spray gun, the first outside surface and/or the second outside surface has applied thereto a material which forms a non-translucent layer upon cooling, for example a coloring agent. If a template is used to produce the required symbol or shape, the non-translucent layer is attached to the translucent layer by adhesion of the materials from which they are made. If the non-translucent layer is made from a non-translucent film or foil, parts having the required shape are cut out and attached to the translucent element by means of an adhesive substance. The light source is ted in the cavity in the translucent element.

### CROSS-REFERENCE TO RELATED APPLICATIONS

The present patent application is a National stage application from PCT application PCT/RU2013/000034 filed on Jan. 17, 2013 which claims priority to Russian application No. RU2012135766 filed on Aug. 21, 2012.

### FIELD OF THE INVENTION

The invention relates to decorative elements for automobiles.

### BACKGROUND

An illuminated nameplate for HONDA cars is wellknown and disclosed, for example, on the webpage: DRIVE2.RU. Community of cars and people. LED tuning: Blog. Illuminated nameplate HONDA. URL: http://www.drive2.ru/communities/ledtuning/blog/288230376151805419/ (application date 22 Mar. 2012). The illuminated nameplate consists of an opaque translucentnameplate, a diode strip, translucenttranslucent insert and fastening means. The nameplate has a recess which houses the diode strip. On the diode strip side, the nameplate is connected to the translucenttranslucent insert. On the opposite side from the connection with the nameplate, the translucent insert is provided with fastening means. The fastening means serve to connect the illuminated nameplate to the surface of the vehicle.

One shortcoming of this solution is the complexity of manufacturing since the part consists of several elements.

Another technical solution is illuminated nameplate of RU patent No. 114296, priority date 13 Dec. 2011 publication date 20 Mar. 2012. The illuminated vehicle nameplate contains a main element with opposite locations of the outer surface and the first inner surface, a translucent element with opposite locations of the second inner surface and the connecting surface, and a light source. The main element is made of opaque material. The first inner of the main element surface are connected with the second inner surface of the translucent element. The light source is made in the form of a light-emitting diode strip and located between the main element and the connecting surface. A groove is made in the translucent element on the side of the second inner surface. The light source is located M the given channel. The device is fixed to the vehicle body by a connecting surface. The light source is connected to the power supply. The illumination from the light source passes through the translucent element and illuminates the perimeter of the nameplate.

The shortcoming of this solution is the complexity of manufacturing since the part consists of several elements.

The closest to the technical solution (prototype) is illuminated nameplate RF patent No. 117370, priority date 13 Dec. 2011. The illuminated vehicle nameplate contains a main element with opposite locations of the outer surface and the first inner surface, a clear element with opposite locations of the second inner surface and the connecting surface, and a light source. The main element is made of opaque material, The first inner surface of the main element is connected with the second inner surface of the clear element. The light source is made in the form of a light-emitting diode strip and located between the main element and the connecting surface. The light source is made in the form of a luminescent wire.

The shortcoming of this solution is the complexity of manufacturing since the part consists of several elements.

The purpose of the proposed invention is to simplify the design of the device.

### SUMMARY

The set goal is achieved as follows: the illuminated vehicle nameplate has a light source and a light flow distributor including a first wall and second wall, the first wall being limited by the opposite located first inner surface and first outer surface, the second wall being limited by the opposite located second outer surface and second inner surface, and also a connecting surface located opposite to the connection between the second wall and the first wail and made to provide for fastening to the vehicle body; the second wall is clear; a cavity is made in the light flow distributor; a cavity is formed in the first inner surface and of the second inner surface, a the light source is placed in the cavity, distinguished by having an opaque layer; the first wall is made of clear material; the first wall and second wall are made in one; the opaque layer is located at least on part of the first outer surface.

### BRIEF DESCRIPTION OF DRAWINGS

FIG. 1 shows one embodiment of the device in cross section.

### DETAILED DESCRIPTION OF THE PREFERRED EMBODIMENT

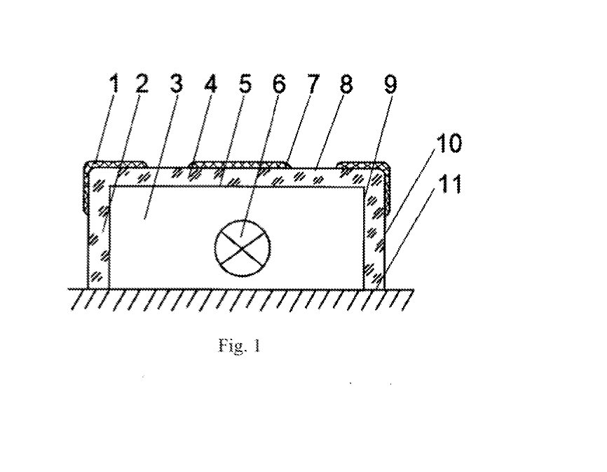

The FIG. 1 shows: an opaque layer 1, a second wall 2, a cavity 3, a first wall 4, a first inner surface 5, a light source 6, a first outer surface 7, a light passage section 8, a second inner surface 9, a second outer surface 10, and a connecting surface 11.

The main elements of the device are the light flow distributor (hereinafter referred to as the clear element), the opaque layer 1 and the light source 6.

The nameplate constitutes a decorative element for vehicles made in the form of any figure, letter or other symbol. The nameplate is made to provide for attachment to the vehicle body.

The clear element may be made in any form. The clear element consists of the first wall 4 and the second wall 2. The first wall 4 is located at a certain distance from the vehicle body after the device it attached thereto. The second wall 2 is located close to the fastening of the clear element to the vehicle body. At the same time, if the clear element is made in rounded form, such as part of a sphere, division of the clear element into the first wall 4 and the second wall 2 is arbitrary. The first wall 4 is limited by the first outer surface 7 and the first inner surface 5. The first outer surface 7 and the first inner surface 5 are located opposite each other. The first outer surface 7 faces outwards, i.e., in the direction from the cavity 3 with the light source 6. The first inner surface 5 faces the cavity 3 with the light source 6. Along the perimeter, the first wall 4 is connected with the second wall 2. The second wall 2 is limited by the second outer surface 10, the second inner surface 9 and the connecting surface 11. The second inner surface 9 and the second outer surface 10 are located opposite each other. The connecting surface 11 is located opposite the connection between the second wall 2 and the first wall 4, The connecting surface 11 is made to provide for the device to be secured to the vehicle body. The cavity 3 is formed by the first inner surface 5 and the second inner surface 9. The clear element is made of clear material, i.e., of material that lets light through, such as glass, or clear plastic, including matt plastic of any colour and diffusing the light passing through it.

The light source 6 consists of any source of light applicable in the given sphere, such as a light-emitting diode or several light-emitting diodes or a strip of light-emitting diodes or a flexible rod made to provide bright even light throughout its length, such as an electroluminescent wire. The light source 6 is placed in the cavity 3.

The opaque layer 1 consists of a thin layer of opaque material, i.e., material that does not let light through by either absorbing or reflecting it. The opaque layer 1 consists of, for instance, a thin opaque film connected to the relevant surface (the first outer surface 7 or the second outer surface 10) or a layer of opaque material applied to this surface. Opaque layer 1 is located on at least part of the first outer surface 7 and/or part of the second outer surface 10. At the same time, opaque layer 1 may be made integral or consisting of several separate parts, The opaque layer 1 is connected to the first outer surface 7 and/or the second outer surface 10 by any known means, such as interatomic connections, adhesion between the materials of the opaque layer 1 and the clear element, or by means of an adhesive substance or any other known method,

The parts of the first wall 4 and/or the second wall 2 not covered with the opaque layer 1 form the light passage sectors 8, The positioning of the parts of the opaque layer 1 on the first outer surface 7 and/or the second outer surface 10 allows for formation of the required symbol or figure by the given parts of the opaque layer 1 or for formation of the required symbol or figure by the light passage sectors 8,

### INDUSTRIAL APPLICABILITY

The invention is realised as follows,

The following are made: the light source 6, the clear element with the first wall 4 and the second wall 2, the opaque layer 1 or material for forming it, A material, such as a paint substance, is applied to the first outer surface 7 and/or the second outer surface 10, using, for example, a spray gun and, after setting, it forms the opaque layer 1, At the same time, for forming the required symbol or figure, a stencil may be used. In this case, the opaque layer 1 is attached to the clear element through adhesion of the materials of which it is made. lf opaque layer 1 is made of an opaque film or foil, the shape of the required form is cut out and the layer is then attached to the clear element, for instance using an adhesive. The light source 6 is placed in the cavity of the clear element, The design of the device is thus simplified and the time for making it reduced, since there is no need to manufacture parts out of different materials, such as clear plastic or opaque plastic as in the prototype, and also since there is no need to attach these parts.

The connecting surface 11 of the device is attached to the vehicle body by a means such as an adhesive. The wires from light source 6 are connected to the vehicle's dashboard power supply. The first outer surface 7 is turned away from the vehicle body, When the dashboard power supply is switched on, light source 6 lights up, The light emitted by the light source 6 does not pass through the material of opaque layer 1, i.e., the light is absorbed or reflected thereby. The light emitted passes through light passage sectors 8 of the dear element.

Manufacture of the clear element by applying an opaque layer thereto and placing a light source in the cavity of the clear element thus simplifies the design of the device by making the clear element integral and blocking out parts of the device by means of the opaque layer.

What is claimed is:

1. An illuminated vehicle nameplate, comprising: a light source and a light flow distributor, the light flow distributor including a first wall and a second wall, the first wall being limited by opposite located a first inner surface and a first outer surface, the second wall being limited by opposite located a second outer surface and a second inner surface, and also a connecting surface located opposite to a connection between the second wall and the first wall and made to provide for fastening to a vehicle body; the second wall being clear; a cavity is made in the light flow distributor; the cavity is formed by the first inner surface and the second inner surface, the light source is placed in the cavity, further comprising an opaque layer; the first wall is made of clear material; the first wall and second wall are made in one piece; the opaque layer is located at least on a part of the first outer surface.
